(19) United States
(12) Patent Application Publication
(10) Pub. No.: US 2019/0135165 A1
(43) Pub. Date: May 9, 2019

(54) LIGHTING DEVICE FOR A MOTOR VEHICLE

(71) Applicant: Hella GmbH & Co. KGaA, Lippstadt (DE)

(72) Inventors: Carsten Wilks, Lippstadt (DE); Boris Kubitza, Möhnesee-Körbecke (DE)

(21) Appl. No.: 16/091,327

(22) PCT Filed: Apr. 7, 2017
(86) PCT No.: PCT/EP2017/058391

§ 371 Date: Oct. 4, 2018

(30) Foreign Application Priority Data
Apr. 12, 2016 (DE) 10 2016 106 649.4

(51) Int. Cl. B60Q 1/14; F21S 41/13; F21S 41/64

(52) U.S. Cl. CPC B60Q 1/1423; F21S 41/645; F21S 41/13

(57) ABSTRACT

A lighting device for a motor vehicle, comprising several light sources and at least one means of radiation for electro-magnetic radiation. The light sources are designed to emit electromagnetic radiation which is visible to the human eye. The means of radiation is designed to emit electromagnetic radiation which is not visible to the human eye. The lighting device further comprises a means of detection for the electromagnetic radiation emitted by the means of radiation and an adjusting means. The means of detection is designed to emit a signal to the adjusting means comprising an indication relating to a radiation direction of the non-visible electromagnetic radiation. The adjusting means is designed to influence a radiation direction of the non-visible electromagnetic radiation and a radiation direction of the visible electromagnetic radiation, depending on the signal.

### CROSS REFERENCE

This application claims priority to PCT Application No. PCT/EP2017/058391, filed Apr. 7, 2017, which itself claims priority to German Patent Application 10 2016 106649.4, filed Apr. 12, 2016, the entirety of both of which are hereby incorporated by reference.

### FIELD OF THE INVENTION

The description relates to a lighting device for a motor vehicle.

### BACKGROUND

Such lighting devices for motor vehicles can also be called headlamps and they serve to illuminate the driving lane in front of the motor vehicle so that a driver of the motor vehicle can detect obstacles and unevennesses in the dark. The lighting devices may either be halogen, xenon, LED or laser headlamps.

LED-headlamps normally consist of several arrays, on each of which several LEDs are arranged. In particular in LED headlamps, the radiation direction of the headlamp can be influenced. This may for example be achieved by means of swiveling arrays.

In the state of the art, the radiation direction is determined by a means of detection and it is detected whether a change of the radiation direction is to be executed.

Detection is therefore executed by means of the visible light. There is, therefore, a marking visible at least for the means of detection, when the light hits the road surface in front of the motor vehicle.

From WO 2013/084919 A1, a lighting device is known which comprises several means of radiation. One part of the means of radiation radiates visible light, the other part radiates infra-red radiation, which is not visible to the human eye.

### SUMMARY OF THE INVENTION

Compared to the state of the art, the invention is based on the task of creating a lighting device for a motor vehicle allowing a particularly good illumination of the road surface in front of the motor vehicle. Furthermore, a procedure for the adjustment of such a lighting device shall be created.

The lighting device comprises several light sources, which are designed to emit electromagnetic radiation which is visible to the human eye. Furthermore, the lighting device comprises at least one means of radiation for electromagnetic radiation which is not visible to the human eye. This radiation can be particularly in the infra-red range. Furthermore, the lighting device comprises a means of detection for the electromagnetic radiation emitted by the means of radiation and a means of adjustment. The means of detection is designed to emit a signal to the means of adjustment comprising an indication of a radiation direction of the non-visible electromagnetic radiation. The means of detection can also be designed to detect the non-visible electromagnetic radiation and to not detect the light, so that the light does not interfere with the detection of the non-visible electromagnetic radiation.

The means of adjustment is designed to influence a radiation direction of the non-visible electromagnetic radiation and a radiation direction of the visible electromagnetic radiation, depending on the signal.

It is therefore possible to adjust the radiation direction by means of the non-visible electromagnetic radiation. Therefore, no marking visible to the human eye at all is required in the light pattern of the lighting device for the adjustment of the radiation direction. Thus, the driver is offered a particularly good illumination without any markings visible to him. This makes it in particular possible to adjust the radiation direction by using the means of detection during driving.

According to an embodiment of the invention, the lighting device can comprise several, in particular at least three, means of radiation the non-visible electromagnetic radiation of which can be detected by the means of detection. Herein, the means of detection is designed to emit the signal depending on the radiation direction of the several means of radiation. The use of several means of radiation has the advantage that an adjustment of the radiation direction can be executed in a more accurate manner. The radiation can, after all, differ from the desired radiation direction in three dimensions.

At least three means of radiation are particularly advantageous to exactly calculate from the radiation direction of all means of radiation how the radiation direction is to be changed.

According to an embodiment of the invention, the means of adjustment can be designed to directly influence the radiation direction. This can for example mean, that the means of adjustment is designed to change the arrangement or the orientation of the one or several means of radiation and the light sources. The means of adjustment can for example be designed to swivel an array on which the means of radiation and the light sources are arranged.

According to an embodiment of the invention, the means of adjustment can be designed to swivel the one or several means of radiation and the light sources in at least one direction, and in particular in at last two directions depending on the signal. The swivel ability in two directions has in particular the advantage that the radiation direction can be set more accurately. An array on which one or several means of radiation and the light sources are arranged, can for example be swiveled around a vertical axis and a longitudinal axis by means of the means of adjustment.

According to an embodiment of the invention, the means of adjustment can be designed to indirectly influence the radiation direction. This can for example mean, that an optical means, such as for example a lens or a lens system, which influences the radiation direction, can be moved by the means of adjustment.

According to an embodiment of the invention, the lighting device can comprise an optical means for influencing the radiation direction. This can for example be a lens or an optical system designed to influence the radiation direction. The means of adjustment can be designed to swivel the means for influencing the radiation direction in at least one direction and in particular in at least two directions, depending on the signal. The swivel ability in two directions has in particular the advantage that the radiation direction can be set more accurately.

According to an embodiment of the invention, the one or several means of radiation and the light sources can be arranged in a geometric shape. The light sources and the one or several means of radiation can be arranged in a circle or in a rectangle. The geometric form can for example be determined by the shape of the array on which the one or several means of radiation and the light sources are arranged. The one or several means of radiation could be arranged on a peripheral area or several peripheral areas of the geometric shape. Herein, the peripheral area can be the region comprising the outer edge of the geometric form. In an exemplary manner, the means of radiation can be arranged in the corners of the rectangle or on the circumference of the circle. It is also possible, that the peripheral area does not only comprise the light sources and means of radiation arranged on the outermost positions, but also light sources and means of radiation still having a neighboring light source and/or a neighboring means of radiation being arranged further outward.

This arrangement of the means of radiation has in particular the advantage that a change in radiation direction has a large effect on the one or several means of radiation, so that particularly accurate adjustment is possible. Furthermore, the radiation non-visible for the vehicle driver can be noticed in the form of slightly darker areas on the road surface, as a light source could have been replaced by a means of radiation. This slightly darker area is then arranged relatively far towards the outside, so that it is hardly disturbing at all.

According to an embodiment of the invention, the light sources and the one or several means of radiation can be designed to simultaneously emit visible and non-visible electromagnetic radiation.

According to an embodiment of the invention, the non-visible electromagnetic radiation can be in the infra-red range.

Following to the procedure according to Claim 10, electromagnetic radiation visible and non-visible to the human eye is emitted. Herein, the visible radiation is sufficiently strong to illuminate a driving lane surface in front of a motor vehicle so that a driver of the motor vehicle can recognize obstacles and unevenness. A radiation direction of the non-visible electromagnetic radiation is detected. The radiation direction of the non-visible and of the visible electromagnetic radiation is adjusted according to the detected radiation direction.

### DESCRIPTION OF THE DRAWINGS

Reference is now made more particularly to the drawings, which illustrate the best presently known mode of carrying out the invention and wherein similar reference characters indicate the same parts throughout the views.

FIG. 1 is a schematic view of an embodiment of the invention.

FIG. 2 is a schematic view of an embodiment of the invention with an LCD-screen.

FIG. 3 is a schematic view of the device from FIG. 2 with an adjustment pattern.

FIG. 4 is a schematic view of the device from FIG. 2 with an adjustment pattern.

### DETAILED DESCRIPTION OF THE DRAWINGS

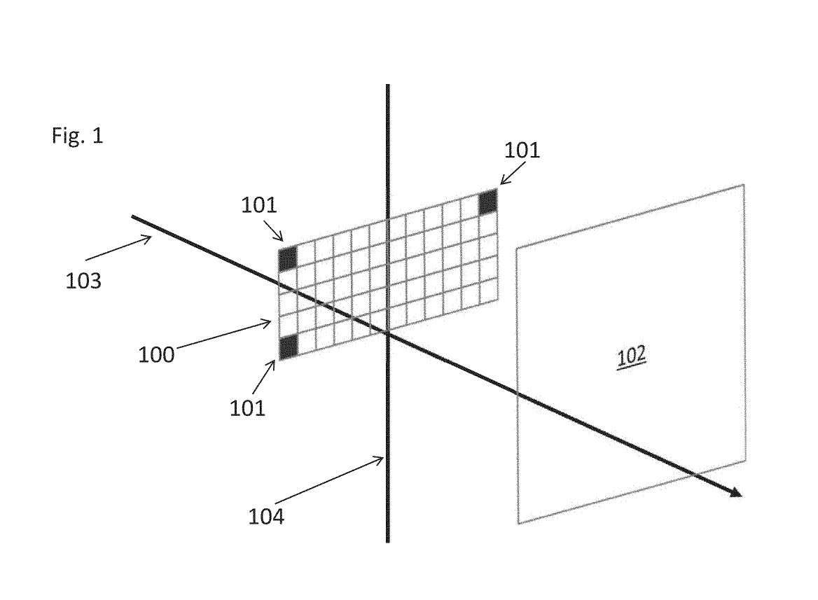

In FIG. 1, several light sources 100 and three means of radiation 101 are arranged in a rectangular pattern. In the drawing, the light sources 100 as well as the means of radiation 101 are represented schematically by means of squares. The light sources 100 are designed to emit light which is visible to the human eye. The means of radiation 101 are designed to emit electromagnetic radiation which is not visible to the human eye. This can for example be infrared radiation. The light sources 100 as well as the means of radiation 101 are preferentially embodied as LEDs.

Furthermore, an optical means for influencing the radiation direction 102 is represented, which is designed to influence a radiation direction of the light emitted by the light sources 100 and of the electromagnetic radiation emitted by the means of radiation 101. The means for influencing the radiation direction 102 can, for example, be a lens or a system comprising several lenses.

Also, two swivel axes 103 and 104 are represented in FIG. 1, around which the light sources 100 and the means of radiation 101 can be swiveled. By swiveling around the swivel axis 103, the range of light of the light sources 100 and of the means of radiation 101 can be adjusted. The further downward the light sources 100 and the means of radiation 101 radiate their respective radiation, the shorter is the range of the light. By swiveling around the swivel axis 104, the radiation direction of the emitted radiation can be swiveled in the horizontal plane. This can for example be used for the realization of bend lighting in a motor vehicle.

The means of radiation 101 are used for the adjustment of the radiation direction of the light sources 100. To this end, a detection means not represented in the figures is provided, which can detect non-visible electromagnetic radiation. For example, by means of the non-visible radiation detected on the surface of a driving lane in front of the vehicle, the position of the means of radiation 101 and of the light sources 100 can be calculated and whether correction is possibly required.

The use of three means or radiation 101 is advantageous to gain a great deal of information on the radiation direction of the light and on the non-visible electromagnetic radiation. When swiveling around the swivel axis 104, it is advantageous to use at least one means of radiation 101 to the right and to the left of the swivel axis 104. When swiveling around the swivel axis 103 for headlamp levelling, it is advantageous to use at least one means of radiation above and below the swivel axis 103. By arranging one of the means of radiation 101 in a top right area, in a top left area and in a bottom left area, those two advantages can both be used.

The means of radiation 101 are arranged in the outermost corner areas of the rectangular shape. This arrangement has the advantage, that the means of radiation 101 are relatively far from the swivel axes 103 and 104 and are subject to the largest swiveling motion. Therefore, the adjustment of the radiation direction can be executed more accurately.

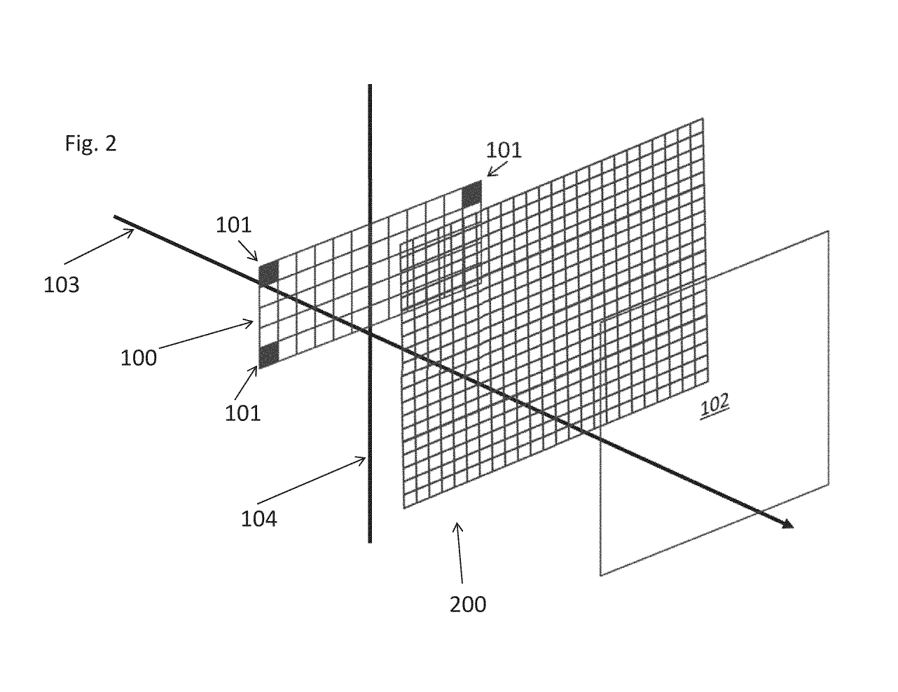

FIG. 2 shows an LCD-screen 200 which consists of several segments. Each of the segments can assume two states. In a first state, the light of the light sources 100 as well as the non-visible radiation of the means of radiation 101 can pass. In a second state, the light of the light sources 100 as well as the non-visible radiation of the means of radiation 101 is blocked. This can for example be achieved by polarizing the radiation and/or the light and by using a liquid crystal.

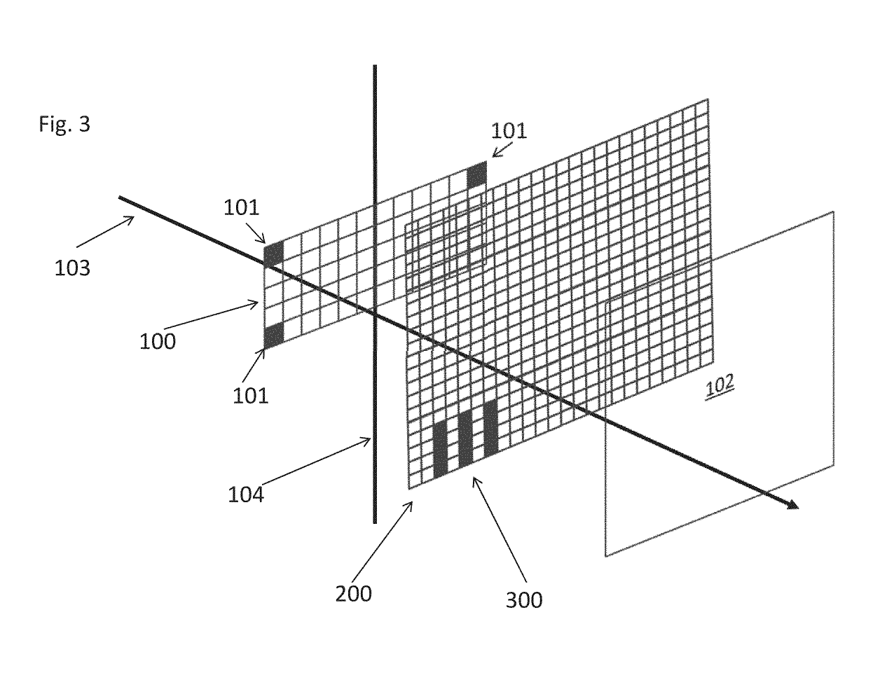

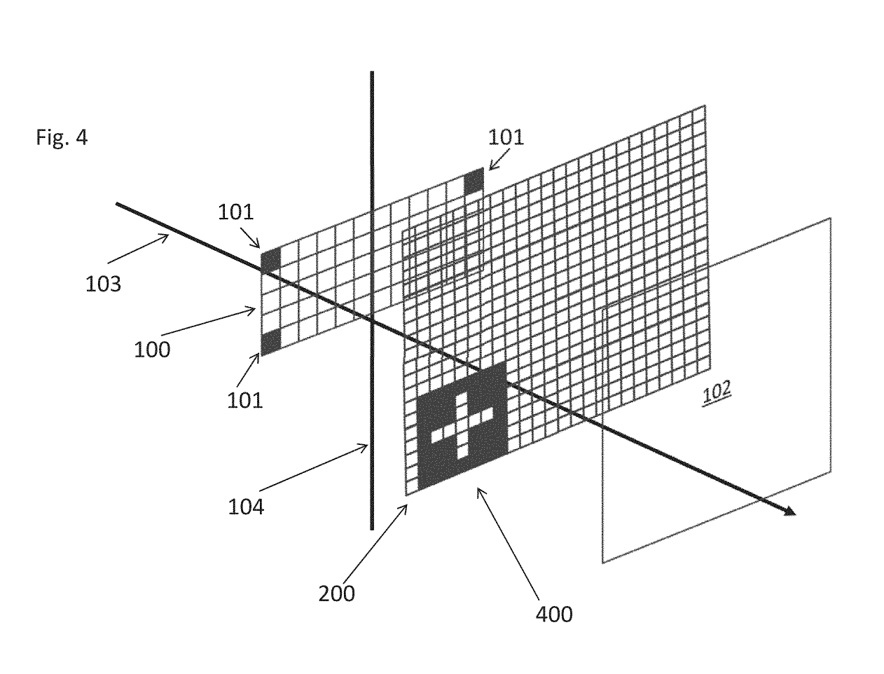

In FIGS. 3 and 4, the patterns 300 and 400 are represented, which can be set on the LCD-screen 200. To this end, some of the segments of the LCD-screen are switched to the second state. They are represented in black in the FIGS. 3 and 4. Pattern 300 shows a striped pattern and pattern 400 shows a cross. Both patterns 300 and 400 can be used for the adjustment of the radiation direction of the light and of the non-visible electromagnetic radiation. The means of detection can in particular be embodied to detect the non-visible electromagnetic radiation and to not detect the light.

The means of detection is embodied to emit a signal comprising an indication of the radiation direction of the non-visible electromagnetic radiation. For example, a desired position of the pattern 300 or 400 on a driving lane surface in front of a motor vehicle can be specified and the means of detection emits a signal when the desired position is not identical with the actual position. A means of adjustment can then correct the radiation direction, so that the pattern 300 or 400 is in the desired position.

It is in particular advantageous to use the non-visible electromagnetic radiation for the detection of the radiation direction, as the pattern is difficult to detect by the driver or not at all. The light distribution perceived by the driver on the road surface is hardly disturbed by the pattern 300 or 400 and the means of radiation 101 or not at all.

### LIST OF REFERENCE SIGNS

100 Light sources
101 Means of radiation
102 Means for influencing the radiation direction
103 Swivel axis
104 Swivel axis
200 LCD screen
300 Pattern
400 Pattern

1. A lighting device for a motor vehicle, the lighting device comprising:
at least two light sources and at least one means of radiation for electro-magnetic radiation, wherein the light sources emit electromagnetic radiation which is visible to the human eye, and wherein the means of radiation emits electromagnetic radiation which is not visible to the human eye;
a means of detection for the electromagnetic radiation emitted by the means of radiation and an adjusting means, wherein the means of detection emits a signal to the adjusting means to indicate a radiation direction of the non-visible electromagnetic radiation,
wherein the adjusting means influences a radiation direction of the non-visible electromagnetic radiation and a radiation direction of the visible electromagnetic radiation, depending on the signal.

2. The lighting device according to claim 1, wherein the lighting device comprises at least three means of radiation, the non-visible electro-magnetic radiation of which can be detected by the means of detection, and that the means of detection emits the signal depending on the radiation direction of the at least three means of radiation (101).

3. The lighting device according to claim 1 wherein the adjusting means directly influences the radiation directions.

4. The lighting device according to claim 1 wherein the adjusting means swivels at least one of the means of radiation and the light sources in at least one direction depending on the signal.

5. The lighting device according to claim 1 wherein the adjusting indirectly influences the radiation directions.

6. The lighting device according to claim 1 wherein the lighting device comprises an optical means for influencing the radiation direction, and wherein the adjusting means swivels the means for influencing the radiation direction in at least one direction depending on the signal.

7. The lighting device according to claim 1 wherein the at least one means of radiation and the light sources are arranged in a geometric shape, wherein the at least one means of radiation are arranged in one peripheral area or several peripheral areas of the geometric shape.

8. The lighting device according to claim 1 wherein the light sources and the at least one means of radiation are designed to simultaneously emit the visible and the non-visible electromagnetic radiation.

9. The lighting device according to claim 1 wherein the non-visible electromagnetic radiation lies within the infrared range.

10. A procedure for the adjustment of a lighting device for a motor vehicle, the procedure comprising the following steps:
emitting electromagnetic radiation that is both visible and non-visible to the human eye, wherein the visible radiation is sufficiently strong to illuminate a driving lane in front of the motor vehicle to allow a driver of the motor vehicle to detect obstacles and unevennesses in the dark;
detecting a radiation direction of the non-visible electromagnetic radiation; and
adjusting the radiation direction of the non-visible and of the visible electromagnetic radiation depending on the detected radiation direction.
